(19) United States
(12) Patent Application Publication
(10) Pub. No.: US 2012/0264219 A1
(43) Pub. Date: Oct. 18, 2012

(54) LEAK DETECTION DEVICE

(76) Inventors: Brian Robert Sinclair, Tuart Hill (AU); Shreepad Krishna Bhat, Bull Creek (AU)

(21) Appl. No.: 13/516,331

(22) PCT Filed: Dec. 1, 2010
(86) PCT No.: PCT/AU10/01619

§ 371 Date: Jun. 15, 2012

(30) Foreign Application Priority Data
Dec. 21, 2009 (AU) 2009906203
Mar. 26, 2010 (AU) 2010100274
Mar. 26, 2010 (AU) 2010901280

(51) Int. Cl. G01N 31/22

(52) U.S. Cl. 436/3; 422/425

(57) ABSTRACT

A leak detection device (10) comprising a first membrane (12), the first membrane (12) containing at least one indicator chemical (16) responsive to anaerobic conditions, wherein the first membrane (12) is at least in part semi-permeable such that it allows passage of oxygen therethrough substantially in only one direction.

### FIELD OF THE INVENTION

The present invention relates to a leak detection device. More particularly, the leak detection device of the present invention is intended for use in the detection of gas leaks from pressure containment joints by way of a visible colour change in at least a. portion of the leak detection device.

### BACKGROUND ART

Presently, economic and practical devices for the passive monitoring of the integrity of pressure containment joints are unavailable. Such a device would find use in process industries, including petroleum, hydrocarbon, petrochemical, pharmaceutical, nuclear, agricultural and the like industries.

The requirements for such monitoring devices would be as diverse as the particular fluids/gas services utilised in these industries. For example, a single plant has a multitude of fluid/gas services and it becomes impractical to implement multiple passive monitoring devices to detect specific types of forms of fluids/gas that may be leaked to the environment.

Presently, in most applications active leak detection devices are implemented only in particularly critical and hazardous areas. Such leak detection devices are typically installed at a location spaced apart from the potential leak source so as to ensure that the devices do not cause obstruction to the movement of personnel and machinery in the plant. Accordingly, such devices detect leaks only when the fluid/gas leaks at a rate that is sufficiently significant to reach these devices, despite any loss of fluid/gas to the atmosphere. A further weakness that is inherent in such active devices or systems is that the reliability of monitoring is limited by the reliability of the specific products and the power supply system, including the integrity of the cabling system thereto. In an attempt to overcome this weakness, most active systems are “inter locked” with another system as back-up verification before an operator would be notified or “alarmed”.

In U.S. patent application Publication US 2005/0042758 there is disclosed a method for the detection of volatile organic compounds (“VOCs”) from pressurised systems using particular chemical dye indicators. Importantly, methane and carbon dioxide are excluded from the compounds that can be detected through this method. The method relies upon the reaction between the leaking gas and an indicated dye chemical, using micro-capsules of the reactive dye ‘precursor’ chemicals coated on a sheet, together with a developer and a filler, also present on the paper sheet. Such a construction is particularly complicated, making manufacture of such an indicator problematic. Further, the method disclosed is entirely independent of differential pressure across the leak detection device employed.

International Application PCT/US2004/042264 (WO 2005/059500) discloses a method or process for the detection of leaks in sealed packages, applicable to the packaging industry. Firstly, this invention relates to non-pressurised systems. Secondly, the invention is directed to the detection of oxygen, so as to protect against degeneration of contents in sealed packages. This method further relates to the use of multilayer films, including an indicator layer and an oxygen barrier layer. The use of such an oxygen barrier layer makes such a film inappropriate for use in circumstances requiring the passage of oxygen through the indicator device. This method also describes the use of a form of illumination that contains a specific wave-length light that is absorbed by the oxygen sensitive indicator and which produces an emission of radiation in an amount inversely proportional to the level of oxygen present.

International Application PCT/FI99/01021 (WO 00/67014) relates to a leakage indicator and a package provided with such a leakage indicator. As such, this indicator is again for use in the packaging industry, again in a non-pressurised system. As above, this invention is focused on the detection of oxygen so as to prevent the degeneration of the contents in sealed packages, particularly packaging containing ‘protective’ gases, such as carbon dioxide or nitrogen. Yet again, the indicator is provided to indicate the presence of oxygen above a predetermined threshold amount.

U.S. Pat. No. 6,676,901 discloses an “oxygen indicator”. The oxygen indicator of this invention is directed to use in a “deoxidiser package”. That is, it is directed to the detection of oxygen in a food packaging context. The oxygen indicator described comprises an oxygen indicating agent that includes a substrate and an oxygen indicator composition that is fixed on the surface of the substrate, and a self-adhesive plastic member. A tape or strip of the oxygen indicator is described as being fixed to the interior of a food packaging container to provide a visible indication of oxygen intrusion into the packaging. Whilst this oxygen indicator is described as having a certain oxygen and moisture permeability there is no indication of any directional element to such permeability. The applications to which the oxygen indicator are described as being applied would not appear to require any specific directional nature to such permeability. However, such an oxygen indicator would not be appropriate for use in circumstances that demanded such a directional element.

The leak detection device of the present invention has as one object. thereof to overcome substantially one or more of the above problems associated with the prior art, or to at least provide a useful alternative thereto.

The preceding discussion of the background art is intended to facilitate an understanding of the present invention only. It should be appreciated that the discussion is not an acknowledgement or admission that any of the material referred to formed part of common general knowledge as at the priority date of the application.

Throughout this specification, unless the context requires otherwise, the word “comprise”, or variations such as “comprises” or “comprising”, will be understood to imply the inclusion of a stated integer or group of integers but not the exclusion of any other integer or group of integers.

### DISCLOSURE OF THE INVENTION

In accordance with the present invention there is provided a leak detection device comprising a first membrane, the first membrane characterised in that it contains at least one indicator chemical responsive to anaerobic conditions, wherein the first membrane is at least in part semi-permeable such that it allows passage of oxygen therethrough substantially in only one direction.

Preferably, the leak detection device further comprises a second or cover membrane arranged to fit over the first membrane. The second or cover membrane is semi-permeable at least in part.

Still preferably, the leak detection device of the present invention further comprises a third or support membrane arranged to provide a base for the first and second membranes, the third or support membrane being similarly semi-permeable at least in part.

Preferably, the indicator chemical is provided in the form .of one or more of a metal organic complex, an organic redox “system”, or a redox indicator.

Still preferably, the indicator chemical is provided as at least two layers of chemical, whereby anaerobic conditions cause the removal or degradation of one of the chemical layers and exposes one of the remaining layers of chemical.

Still further preferably, an adhesive is provided on a surface of the or each membrane whereby the leak detection device may be sealingly engaged with respect to a pressure containment joint to be monitored for leaks.

In one form of the present invention the or each membrane is provided as a strip or tape that may be adhered directly to and over a pressure containment joint from which leaks are to be detected.

In a further form of the present invention, the leak detection device is provided as a component of an enclosure that is provided to fit around a joint from which leaks are to be detected.

In accordance with the present invention there is further provided a method for the detecting of leaks in fluid containment joints, the method characterised in that a leak detection device as described hereinabove is applied over such a joint such that a pocket of air is captured between the device and the joint, any leak of gas from the joint causing the air to be expelled through the device, through differential pressure, from the pocket creating anoxic conditions therein, whereby the chemical indicator is caused to signal a leak.

### BRIEF DESCRIPTION OF THE DRAWINGS

The leak detection device of the present invention will now be described, by way of example only, with reference to five embodiments thereof and the accompanying drawings, in which:

FIG. 1 is a lower perspective view of a leak detection device in accordance with a first embodiment of the present invention;

FIG. 2 is both an upper perspective and exploded view of a leak detection device in accordance with a second embodiment of the present invention;

FIG. 3 is a cross-sectional view of the leak detection device of FIG. 2 in use on a pressure containment joint;

FIG. 4 is a cross-sectional view of the leak detection device of FIGS. 2 and 3 in use on a pressure containment joint, in which there has been a leak of gas;

FIG. 5 is a cross-sectional side view of a leak detection device in accordance with a third embodiment of the present invention in use on a pressure containment joint of the hub connector type or similar;

FIG. 6 is a cross-sectional side view of the leak detection device of

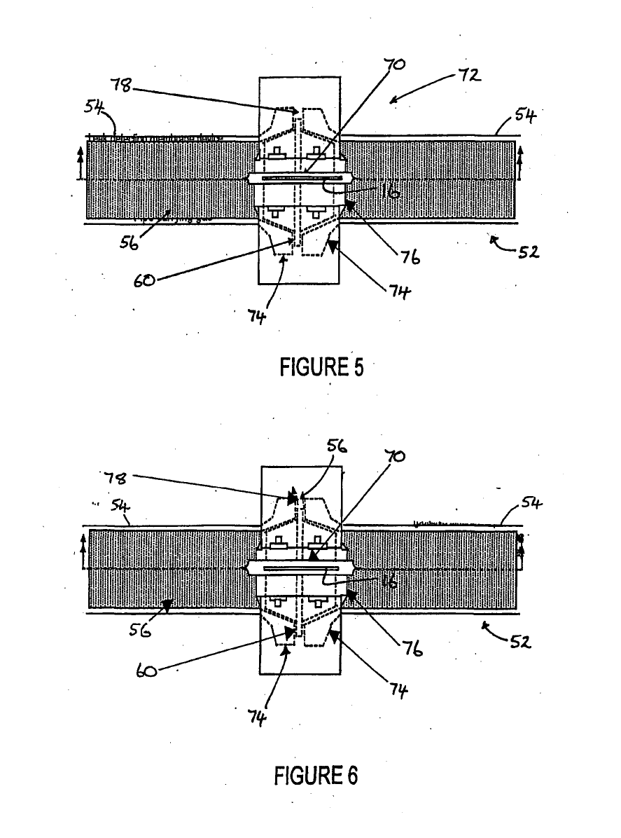

FIG. 5 shown in use on a hub connector type pressure containment joint, in which the leak detection device has detected a leak;

FIG. 7 is a cross-sectional side view of a leak detection device in accordance with a fourth embodiment of the present invention in use on a hub connector type pressure containment joint;

FIG. 8 is a cross-sectional side view of the leak detection device of FIG. 7 shown in use of a hub connector type pressure containment joint, in which the leak detection device has detected a leak; and

FIGS. 9a, 9b and 9c show a leak detection device in accordance with a further embodiment of the present invention showing the flexible enclosure provided about a vessel closure and threaded joint.

### BEST MODE(S) FOR CARRYING OUT THE INVENTION

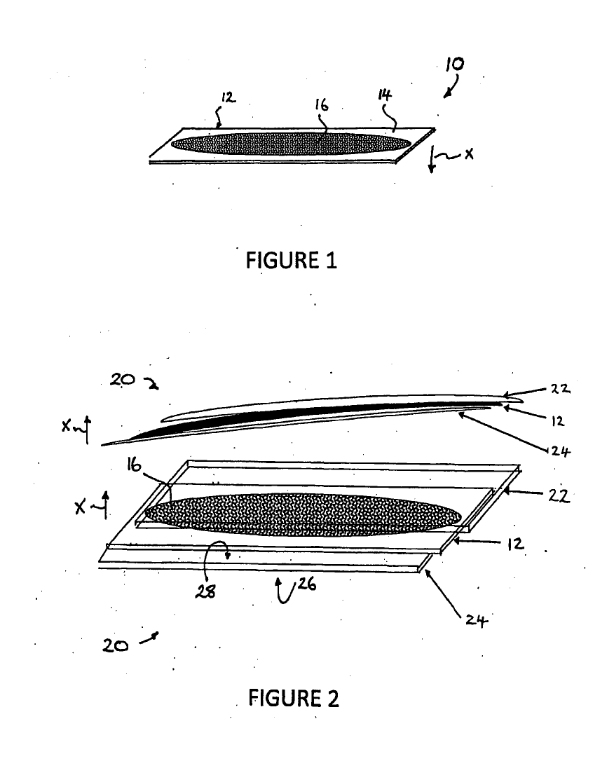

In FIG. 1 there is shown a leak detection device 10 in accordance with a first embodiment of the present invention. The device 10 comprises a first membrane 12 hiving a bottom surface 14 to at least part of which an indicator chemical 16 has been applied. The manner of application, or the manner in which the first membrane contains the indicator chemical 16, may encompass a simple placement of the indicator chemical 16 thereon or may constitute an embedding or soaking of the indicator chemical 16 into the first membrane 12. The first membrane 12 is formed of a suitable material such that it is semi-permeable over at least a portion of its area, whereby it is at least permeable to oxygen but in only a single direction, that direction being indicated by an arrow X in FIG. 1.

The device 10 is provided generally as a strip or tape of indefinite length, although it is to be understood that such may be provided in distinct lengths should a user desire such a configuration.

The indicator chemical 16 may be provided in the form of one or more of a metal organic complex, an organic redox “system”, or a redox indicator of generally known type.

It is envisaged that the indicator chemical may be provided as at least two layers of chemical, whereby anaerobic conditions cause the removal or degradation of one of the chemical layers and exposes one of the remaining layers of chemical as the indicator of a leak (as having caused oxygen depletion in the area adjacent the indicator as will be described hereinafter).

In FIG. 2 there are shown two views of a leak detection device 20 in accordance with a second embodiment of the present invention. The device 20 is substantially similar to the device 10 and like numerals denote like parts. In addition to the first membrane 12 there are provided a second or cover membrane 22 and a third or support membrane 24. The first membrane is effectively sandwiched between the second and third membranes 22 and 24.

The third membrane 24 comprises a bottom surface 26 and a top surface 28. The bottom surface 26 has an adhesive provided thereon, by which the leak detection device 20 may be adhered to an item from which a leak may be detected. The second membrane 22 is at least in part transparent such that at least a portion of the indicator chemical 16 is visible therethrough.

Each of the second and third membranes 22 and 24 are semi-permeable over at least a portion of their area, whereby they are at least permeable to oxygen but in only a single direction, that direction again being as indicated by arrow X. Should each of the membranes 10, 22 and 24 be semi-permeable over only a portion of their area it is desirable that these portions align such that oxygen may pass through the leak detection device 20.

Each of the membranes 12, 22 and 24 are formed of material that is substantial enough to sustain differential pressures as may be encountered across the devices 10 and 20 when in use.

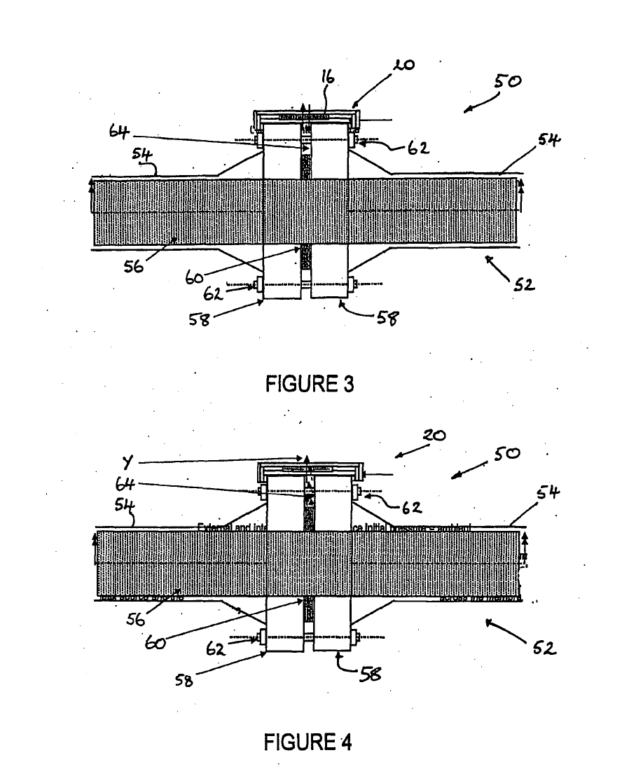

In FIGS. 3 and 4 there is shown the leak detection device 20 in use on a flange joint 50 in a gas line 52. This description of use of leak detection device 20 is also largely applicable to the use of the leak detection device 10 described above. The gas line 52 comprises two piping elements 54 butted together at the flange joint 50 and through which a gas 56 is conveyed, the gas 56 not containing a significant proportion of oxygen. A significant proportion of oxygen may be considered as more than 20% oxygen by weight. The flange joint 50 comprising two flanges 58, one from each piping element 54, between which a gasket 60 is provided, the flange joint 50 being tightened by way of a series of nuts and bolts 62.

As is apparent from FIGS. 3 and 4, the leak detection device 20 is applied across the joint between the flanges 58. The adhesive provided on the bottom surface 26 of the third membrane 24 is used to secure the device 20 to the joint 50. When positioned in this manner there is created a pocket 64, containing air (in turn which contains oxygen) within the joint 50, between the flanges 58, the gasket 60 and the device 20, best seen in FIG. 3. When the pocket 64, containing air, is retained in the joint 50 the indicator chemical 16 will retain the colour it has when in the presence of oxygen.

Should a leak occur in the joint 50, gas 56 from the gas line 52 is able to pass around the gasket 60 and into the pocket of air 64. This action displaces the air through the semi-permeable membranes 10, 22 and 24 of the leak detection device 20 under differential pressure as depicted by arrow Y in FIG. 4. As gas 56 fills the pocket 64 the chemical indicator 16 is no longer exposed to oxygen, the conditions now being anoxic, and as such the chemical indicator 16 will be present in a different colour. This different colour, the colour being dependent upon exactly what form of chemical indicator is used, will be visible to an observer through the second or cover membrane 22. This colour change is maintained due to the selective semi-permeability of the leak detection device 20 whereby oxygen is able to be displaced from the pocket 64 by the gas 56 entering that space and the consequent differential pressure created. Further, continued leak conditions prohibit the entry of atmospheric oxygen/air back into the pocket 64.

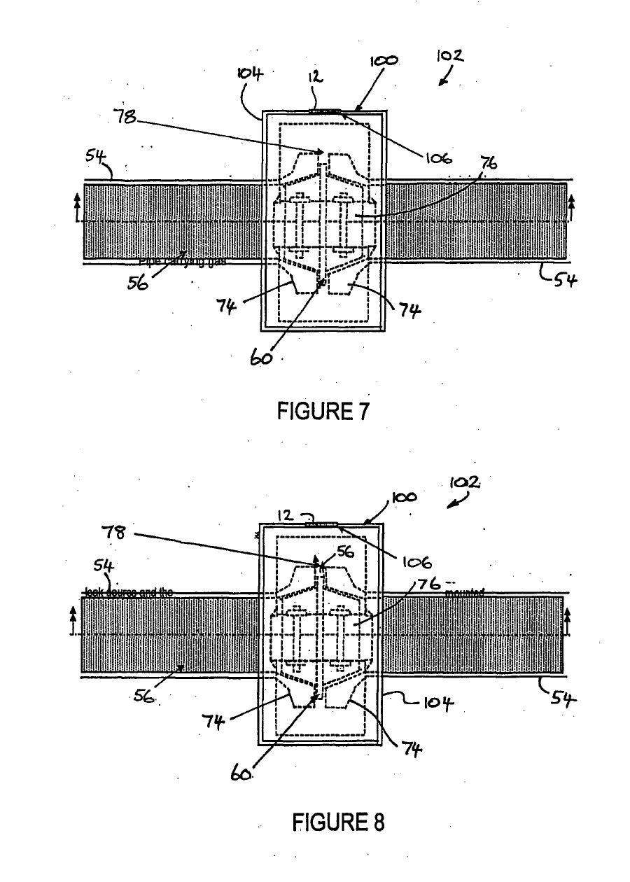

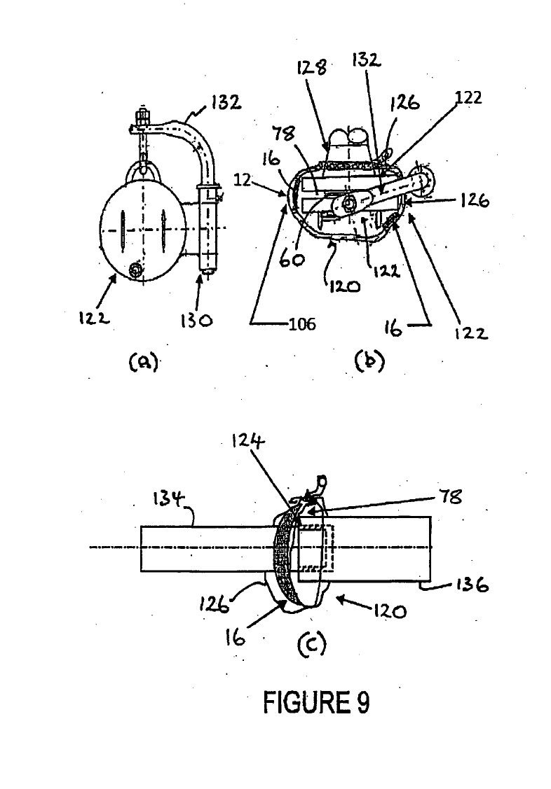

In FIGS. 5 and 6 there is shown a leak detection device 70 in accordance with a third embodiment of the present invention, the device 70 being shown in use on hub connector type joint 72. The leak detection device 70 is substantially similar to the devices 10 and 20 and like numerals denote like parts. Similarly, the hub connector type joint 72 is in many respects similar to the flange joint 50 described above and like numerals again denote like parts.

In the joint 72 the gasket 60 is provided between hubs 74 and the joint 72 tightened by way of bolted clamps 76.

In FIG. 5 the leak detection device 70 is shown in a state in which air is retained in a space 78 between the gasket 60 and the leak detection device 70, wherein the chemical indicator 16 is of a colour that indicates oxygen is present, and consequently that no leak has occurred. In FIG. 6 gas 56 is shown escaping from around the gasket 60 into the space 78. The gas 56 will displace the air from the space 78 through the leak detection device 70 causing the anoxic conditions created to produce a colour change in the chemical indicator 16 that signals the presence of a leak.

In FIGS. 7 and 8 there is shown a leak detection device 100 in accordance with a fourth embodiment of the present invention, the device 100 being shown in use on a hub connector type joint 102. The leak detection device 100 is substantially similar to the devices 10, 20 and 70, and like numerals denote like parts. Similarly, the hub connector type joint. 102 is substantially similar to the joint 72 described above and again, like numerals denote like parts.

The leak detection device 100 comprises a single membrane 12, as described hereinabove in respect of FIG. 1, and an enclosure or container, for example an inert zip box 104. The membrane 12 is provided mounted. across a window 106 provided in the zip box 104.

In FIG. 7 the leak detection device 100 is shown in a state in which air is retained in the space 78 between the gasket 60 and the leak detection device 100, wherein the chemical indicator 16 is of a colour that indicates oxygen is present, and consequently that no leak has occurred. In FIG. 8 gas 56 is shown escaping from around the gasket 60 into the space 78. The gas 56 will displace the air from the space 78 through the leak detection device 100 causing the anoxic conditions created to produce a colour change in the chemical indicator 16 that signals the presence of a leak. This colour change is visible to an observer of the window 106 and the membrane 12 provided therein.

In FIG. 9 there is shown a leak detection device 120 in accordance with a fifth embodiment of the present invention, the device 120 being shown in use on a vessel closure 122 or threaded joint 124. The leak detection device 120 is substantially similar to the devices 10, 20, 70 and 100, and like numerals denote like parts. Similarly, the vessel closure 122 and threaded joint 124 are substantially similar to the joints 72 and 102 described above and again, like numerals denote like parts.

The leak detection device 120 comprises three membranes, as described hereinabove in respect of the second embodiment of the present invention and FIG. 2, and an enclosure or container, for example an inert flexible zip bag 126, as best seen in FIGS. 9(b) and 9(c). The membrane 12 is provided mounted across a window 106 provided in the zip bag 126.

In FIGS. 9a and 9b there is shown the vessel closure 122 comprising a vessel closure nozzle 128, a davit 130 and a vessel closure arm 132. In FIG. 9b the leak detection device 120 is shown in a state in which air is retained in the space 78 between the gasket 60 and the leak detection device 120, wherein the chemical indicator 16 is of a colour that indicates oxygen is present, and consequently that no leak has occurred.

In FIG. 9c there is shown the threaded joint 124 comprising a first pipe member 134 and a second pipe member 136, the member 134 being threadingly engaged with the member 136. Again, in FIG. 9c the leak detection device 120 is shown in a state in which air is retained in the space 78 between the threaded engagement of the members 134 and 136, and the leak detection device 120, wherein the chemical indicator 16 is of a colour that indicates oxygen is present, and consequently that no leak has occurred.

As described previously, should a leak occur from either joint 122 or 124, gas (not shown) entering the space 78 will positively displace air retained therein, thereby creating anoxic conditions in the space 78 that will act on the chemical indicator 16 causing a colour change that may be detected visibly by a user.

In addition to those applications described hereinabove, it is envisaged that the leak detection device of the present invention may have particular application in the detection of leaks in and around valve stems.

It is envisaged that the membranes 12, 22 and 24 may be formed of a durable material, such as may be employed in a tropical marine environment, onshore dusty desert environments and other extreme environments commonly encountered in process industries. As noted previously, the membranes are each selectively permeable to air/oxygen to a predetermined level, preferably in a single direction only, through the provision of pores therein at a suitable size and distribution. As the membranes need to be positioned to span gaps in joints and windows/apertures in containers such will need to possess a basic level of strength. The thickness of the membranes may vary dependent upon their specific application. As examples, the membranes may be formed at least in part of a plastics material, a synthetic elastic material, a natural rubber material or a natural fabric material.

It is further envisaged that the chemical indicator employed is to be non-poisonous and non-toxic, including when burnt. A long shelf life is further preferable.

It is still further envisaged that the chemical indicator may be provided in the form of colour coded “warning letters”, “warning symbols”, or the like. Further, the visible indication of a leak may also be viewed by use of strategically located cameras and viewing devices to facilitate further transmittal of the information/leaking condition to remote locations. Of course, the device of the present invention may be used as a part of general monitoring and alarming systems. Further, the device of the present invention may be useful in monitoring and control of fugitive emissions by selecting membrane sheet material of very low permeability range. Still further, it may be used as a supplemental monitor during piping and equipment pressure integrity testing. Additionally, it may be used as a monitoring device for surface cracks (having potential to develop into through cracks). Yet still further, the device of the ₚresent invention may form part of an overall carbon trading practice/policy.

As can be seen from the above description, the leak detection device of the present invention is suitable for use in, a wide range of applications, including in petroleum/hydrocarbon production facilities, refineries, petrochemical plants, chemical plants, and energy industries, including power plants and the nuclear industry.

Modification and variations such as would be apparent to the skilled addressee are considered to fall within the scope of the present invention.

1. A leak detection device comprising a first membrane, the first membrane including at least one indicator chemical responsive to anaerobic conditions, wherein at least a portion of the first membrane is semi-permeable such that the at least a portion of the first membrane allows passage of oxygen therethrough substantially in only one direction.

2. A leak detection device according to claim 1, wherein the leak detection device further comprises a second or cover membrane arranged to fit over the first membrane.

3. A leak detection device according to claim 2, wherein at least a portion of the second or cover membrane is semi-permeable.

4. A leak detection device according to claim 2, wherein the leak detection device further comprises a third or support membrane arranged to provide a base for the first membrane and the second or cover membrane, wherein at least a portion of the third or support membrane is semi-permeable.

5. A leak detection device according to claim 1, wherein the indicator chemical comprises one or more of the following: a metal organic complex, an organic redox “system”, and a redox indicator.

6. A leak detection device according to claim 1, wherein the indicator chemical comprises at least two layers of chemical, whereby anaerobic conditions cause the removal or degradation of one layer of chemical of said at least two layers of chemical and exposes one remaining layer of chemical of said at least two layers of chemical.

7. A leak detection device according to claim 1, wherein an adhesive is provided on a surface of at least one of the first membrane and the second or cover membrane whereby said adhesive is provided to permit the leak detection device to be sealingly engaged with respect to a pressure containment joint to be monitored for leaks.

8. A leak detection device according to claim 1, wherein the or ouch at least one of the first membrane and the second or cover membrane is provided as a strip or tape that may be adhered directly to and over a pressure containment joint from which leaks are to be detected.

9. A leak detection device according to claim 1, wherein the leak detection device is provided as a component of an enclosure arranged to fit around a joint from which leaks are to be detected.

10. A method for the detecting of leaks in a fluid containment joint, the method comprising:
applying a leak detection device according to claim 1 over a fluid containment joint such that a pocket of air is captured between the leak detection device and the fluid containment joint, and expelling air from said pocket through the leak detection device through differential pressure motivated by a leak of gas from the fluid containment joint into said pocket, creating anoxic conditions in said pocket, whereby the indicator chemical is caused to signal a leak.

11-12. (canceled)
